(19) United States
(12) Patent Application Publication
(10) Pub. No.: US 2009/0252466 A1
(43) Pub. Date: Oct. 8, 2009

(54) AIR BLOWN OPTICAL FIBER UNIT FOR REDUCING MICRO-BENDING LOSS

(75) Inventor: Chan-Yong Park, Seoul (KR)

Correspondence Address: JONES DAY, 222 EAST 41ST ST, NEW YORK, NY, 10017, US

(73) Assignee: LS Cable Ltd., Seoul (KR)

(21) Appl. No.: 11/721,217

(22) PCT Filed: Jun. 30, 2005
(86) PCT No.: PCT/KR2005/002076

§ 371 Date: Jun. 8, 2007

(30) Foreign Application Priority Data
Dec. 8, 2004 (KR) 10-2004-0103194

(51) Int. Cl. G02B 6/44

(52) U.S. Cl. 385/102

(57) ABSTRACT

Disclosed is an air blown optical fiber unit for reducing a micro-bending loss. The air blown optical fiber unit includes at least one optical fiber; a buffer layer surrounding the optical fiber and made of polymer resin having a Young's modulus of 0.05 to 2 kgf/mm; and an outer layer surrounding the buffer layer and having beads attached to a surface thereof, the outer layer being made of polymer resin, wherein the buffer layer has a thickness of 70 to 140 μm. This optical fiber unit may reduce a micro-bending loss of an optical fiber by buffering an external force applied to the optical fiber due to beads attached to its surface.

### TECHNICAL FIELD

The present invention relates to an air blown optical fiber unit, and more particularly to an air blown optical fiber unit for reducing a micro-bending loss.

### BACKGROUND ART

For installation of optical fibers, a method of binding or twisting several optical fibers into a cable, and then installing this cable has been mainly used. In this cable installation method, optical fibers much more than required at the point of installation are generally installed in advance with expectation of future demands.

However, since more various kinds of optical fibers are required according to the trend of new communication environments and there have been developed high performance communication systems suitably coping with communication capacity even in restricted optical fiber installation environments, it cannot be considered desirable that a large amount of optical fibers are installed in advance just with expectation of future demands. In particular, in aspect of a user terminal, namely an access network or a premise wiring, a mode of an optical fiber or cable in future cannot be decided at the present point of time. Thus, if a large amount of optical fibers are installed in advance with incurring much expense, there may be a waste of money if a mode of an optical fiber or cable is changed in future.

In order to solve the above problems, a method for installing an optical fiber unit having several optical fiber strands collected therein by air pressure is widely used. This air blown installation method was firstly proposed by British Telecom Co. (see U.S. Pat. No. 4,691,896) in 1980. In this air blown installation method, a polymer installation tube, called a micro tube or duct, having specific constitution and sectional shape is installed at an optical fiber installation spot in advance, and then an air blown optical fiber unit (hereinafter, referred to just as ‘an optical fiber unit’) is inserted into the micro tube or duct as much as required by air pressure. If optical fibers are installed u sing the above optical fiber installation method, many advantages are ensured, namely easy installation and removal of optical fibers, reduced costs for initial installation, and easy improvement of performance in future.

FIG. 1 is a schematic view showing an optical fiber unit installation device used in the above air blown installation method. Referring to FIG. 1, the installation device successively inserts an optical fiber unit 1 from an optical fiber unit supplier 2 into an installation tube 4 connected to an outlet C of a blowing head 5 by using a driving roller 3 and a pressing means 6, and at the same time blows compressed air toward the outlet C of the blowing head 5 by using the pressing means 6. Then, the conpressed air flows at a fast rate toward the outlet C, and accordingly the optical fiber unit 1 introduced into the blowing head 5 is installed in the installation tube 4 by means of a fluid drag force of the compressed air.

In order to ensure desirable installation of the optical fiber unit 1 in the air blown installation method, the fluid drag force of the compressed air should be great.

The fluid drag force F may be expressed as follows.

$${\vec{F}}_{drag} = {PR}_{1} {R}_{2} \frac{d P}{d L} \qquad Equation 1$$

(P: compressed air pressure, R₁: inner diameter of the installation tube, R₂: outer diameter of the optical fiber unit, L: length of the installation tube)

In the Equation 1, the inner diameter R₁ of the installation tube and the outer diameter R₂ of the optical fiber unit are already defined in standards. Thus, in order to maximize the fluid drag force F, it is preferred to form irregularity on the surface of the optical fiber unit for increasing a contact area between the compressed air and the optical fiber unit.

As a scheme for increasing a contact area between the compressed air and the optical fiber unit, glass beads may be attached on the surface of an optical fiber unit to form irregularity thereon, as disclosed in U.S. Pat. No. 5,042,907 and U.S. Pat. No. 5,555,335.

However, if beads are attached on the surface of the optical fiber unit to form irregularity thereon, irregular external forces are applied to the surface of the surfaces due to the beads. As a result, successive bents are formed on the surface of optical fibers, thereby causing a micro-bending loss.

### DISCLOSURE OF INVENTION

### Technical Problem

The present invention is designed to solve the above problems, and therefore it is an object of the invention to provide an optical fiber unit for reducing a micro-bendilng loss of optical fibers by buffering irregular external forces applied to the optical fibers due to beads attached to the surface of an optical fiber unit.

### Technical Solution

In order to accomplish the above object, the present invention provides an optical fiber unit, which includes at least one optical fiber; a buffer layer surrounding the optical fiber and made of polymer resin having a Young's modulus of 0.05 to 2 kgf/mm²; and an outer layer surrounding the buffer layer and having beads attached to a surface thereof, the outer layer being made of polymer resin, wherein the buffer layer has a thickness of 70 to 140 μm.

In the present invention, preferably, if 4-core optical fibers are used, the buffer layer has a thickness of 70 to 110 μm, while, if 8-core optical fibers are used, the buffer layer has a thickness of 70 to 140 μm.

Here, the outer layer preferably has a Young's modulus of 30 to 100 kgf/mm².

Meanwhile, preferably, if 4-core optical fibers are used, the buffer layer has a diameter of 920 to 1000 μm, while, if 8-core optical fibers are used, the buffer layer has a diameter of 1300 to 1370 μm.

### BRIEF DESCRIPTION OF THE DRAWINGS

These and other features, aspects, and advantages of preferred embodiments of the present invention will be more fully described in the following detailed description, taken accompanying drawings. In the drawings:

FIG. 1 shows an optical fiber unit installation apparatus used for air blown installation of an optical fiber unit;

FIG. 2 is a sectional view showing an air blown optical fiber unit in which 4-core optical fibers are aggregated according to one embodiment of the present invention;

FIG. 3 is a sectional view showing an air blown optical fiber unit in which 8-core optical fibers are aggregated according to another embodiment of the present invention;

FIG. 4 is a photograph showing a section of an air blown optical fiber unit prepared according to an embodiment of the present invention;

FIGS. 5 and 6 are graphs showing measured optical losses of the air blown optical fiber unit according to an embodiment of the present invention;

FIG. 7 is a photograph showing a section of a conventional air blown optical fiber unit; and

FIGS. 8 and 9 are graphs showing measured optical losses of a conventional air blown optical fiber unit.

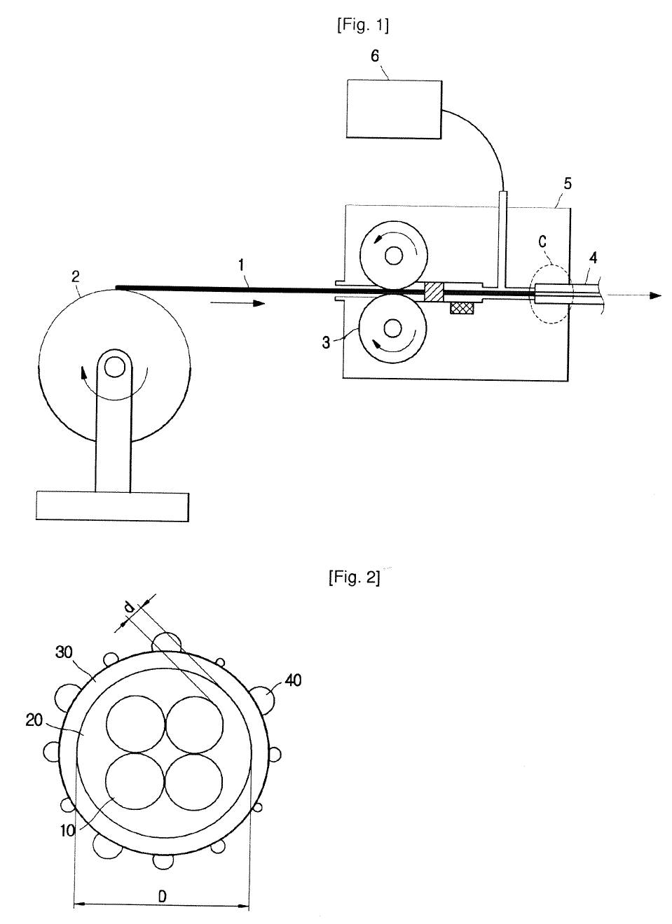

### BEST MODE FOR CARRYING OUT THE INVENTION

Hereinafter, preferred embodiments of the present invention will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

FIG. 2 is a sectional view showing an air blown optical fiber unit in which 4-core optical fibers are aggregated according to one embodiment of the present invention. Referring to FIG. 2, the optical fiber unit of the present invention includes 4-core optical fibers 10 aggregated therein, and a buffer layer 20 and an outer layer 30 subsequently laminated on the surface of the optical fiber 10.

The optical fiber 10 is a single-mode or multi-mode optical fiber, which has a core layer and a clad layer made of quartz. The optical fiber unit may have a single or multiple optical fibers as shown in FIG. 2.

The outer layer 30 is an outermost coating layer to which beads 40 are attached so as to increase a fluid drag force of compressed air during air blown installation. The outer layer 30 is made of radiation curable polymer resin that is cured by radiation, and preferably made of radiation curable acrylate. The outer layer 30 protects the optical fiber 10 against external impacts and keeps its stiffness so that the optical fiber may advance straightly during the air blown installation. For this purpose, the outer layer 30 preferably has a Young's modulus of 30 kgf/mm² or above. However, if the Young's modulus is too high, cracks may be generated too easily. Thus, the Young's modulus of the outer layer 30 is preferably 30 to 100 kgf/mm².

The buffer layer 20 is a coating layer interposed between the optical fibers 10 and the outer layer 30 to directly surround the surface of the optical fibers 10. The buffer layer 20 is made of radiation curable polymer resin that is cured by radiation, and preferably made of radiation curable acrylate, like the outer layer 30. The buffer layer 20 buffers an external force applied to the optical fiber by the beads 40 attached to the outer layer 30, thereby preventing micro bents from being formed on the surface of the optical fiber. In order that the buffer layer 20 gives effective external force buffering actions, it is preferred to consider Young's modulus, thickness and diameter of the buffer layer 20 suitably.

The buffer layer 20 should have a low Young's modulus so as to easily absorb an external force with deforming itself when the external force is applied thereto by the beads 40. Thus, the Young's modulus of the buffer layer 20 is preferably 2 kgf/mm² or below. However, if the Young's modulus of the buffer layer 20 is too low, it is difficult for the buffer layer 20 to keep its own shape, so the Young's modulus of the buffer layer is preferably 0.05 to 2 kgf/mm².

Meanwhile, the thickness of the buffer layer 20 is a straight distance d between a tangent line of the outer circumference of the optical fiber 10 and a tangent line of the outer circumference of the buffer layer 20, which are parallel to each other, as shown in FIG. 2. This thickness of the buffer layer 20 should be not less than a certain level so as to buffer an external force.

In this regards, inventors prepared optical fiber units using single-mode and multi-mode optical fibers with controlling a thickness of the buffer layer 20 and then measured optical losses so as to determine an optimized thickness of the buffer layer 20 while the Young's modulus of the buffer layer 20 is kept in the range of 0.05 to 2 kgf/mm².

First, in an optical fiber unit prepared using a single-mode optical fiber usable in a wavelength range of 1.3 to 1.55 μm, a micro-bending loss was generated in the entire wavelength range if the thickness d of the buffer layer 20 was less than 50 μm. In addition, if the thickness d of the buffer layer 20 was in the range of 50 to 70 μm, a micro-bending loss was not generated in the wavelength range of 1.3 μm but a micro-bending loss was generated in the wavelength range of 1.55 μm. However, if the thickness d of the buffer layer 20 was 70 μm or above, a micro-bending loss was not generated in the entire wavelength range.

In addition, in an optical fiber unit prepared using a multi-mode optical fiber usable in a wavelength range of 0.85 to 1.3 μm, a micro-bending loss was generated in the entire wavelength range if the thickness d of the buffer layer 20 was less than 50 μm. In addition, if the thickness d of the buffer layer 20 was in the range of 50 to 70 μm, a micro-bending loss was not generated in the wavelength range of 0.85 μm but a micro-bending loss was generated in the wavelength range of 1.3 μm. However, if the thickness d of the buffer layer 20 was 70 μm or above, a micro-bending loss was not generated in the entire wavelength range.

Meanwhile, according to BT (British Telecom) standards, an optical fiber unit provided with 4-core optical fibers with a diameter of an optical fiber of 280 μm has a maximum diameter of 1080 μm. In addition, in order to protect the optical fiber, the outer layer 30 preferably has a thickness of at least 40 μm, so the maximum thickness d of the buffer layer 20 is as follows.

Max_Thickness_(d)_of_Buffer_Layer_(20)=(1080−5−560\sqrt{2})÷2≈110 Equation 2

Here, 560√2 is a diameter of the inner circumference of the outer layer 30 that is circumscribed with the 4-core optical fibers. Thus, in case of the optical fiber unit provided with 4-core optical fibers, the buffer layer 20 preferably has a thickness d of 50 to 110 μm, more preferably 70to 110 μm.

In addition, according to BT standards, an optical fiber unit provided with 8-core optical fibers with a diameter of an optical fiber of 280 μm has a maximum diameter of 1450 μm. In addition, as mentioned above, the outer layer 30 preferably has a thickness of 40 μm or above so as to protect the optical fiber, so the maximum thickness d of the buffer layer 20 is as follows.

Max_Thickness_(d)_of_Buffer_Layer_(20)=(1450−80−1100)÷2≈140 Equation 3

Here, 1100 is a diameter of the inner circumference of the outer layer 30 that is circumscribed with the 8-core optical fibers. Thus, in case of the optical fiber unit provided with 8-core optical fibers, the buffer layer 20 preferably has a thickness d of 50 to 140 μm, more preferably 70 to 140 μm.

Meanwhile, while a liquid coating resin is coated on an optical fiber unit to form the buffer layer 20, an optical fiber may be moved to depart from the center portion of the optical fiber unit. If the optical fiber 10 is leaning to any direction, the thickness d of the buffer layer 20 may be locally decreased, which is apt to cause generation of micro-bending loss. Thus, it is preferred that a diameter D of the buffer layer is considered together with the thickness d of the buffer layer 20 to decrease a micro-bending loss. Inventors prepared optical fiber units using single-mode and multi-mode optical fibers with controlling a thickness of the buffer layer 20 and then measured optical losses so as to determine an optimized diameter D of the buffer layer 20.

First, in case of an optical fiber unit having 4-core optical fibers as shown in FIG. 2, optical fiber units were prepared using a single-mode optical fiber usable in a wavelength range of 1.3 to 1.55 μm and a multi-mode optical fiber usable in a wavelength range of 0.85 to 1.3 μm with changing a diameter D of the buffer layer 20, and then their optical losses were measured. At this time, the buffer layer 20 is set to have a Young's modulus in the range of 0.05 to 2 kgf/mm².

As a result of the measurement, in case the diameter D of the buffer layer 20 was less than 900 μm, a micro-bending losses was generated in the entire wavelength range of both of the single-mode optical fiber and the multi-mode optical fiber. In addition, in case the diameter D of the buffer layer 20 was in the range of 900 to 920 μm, a micro-bending loss was not generated in the wavelength of 1.3 μm in case of the single-mode optical fiber, while a micro-bending loss was generated in the wavelength of 1.55 μm. In case of the multi-mode optical fiber, a micro-bending loss was not generated in the wavelength of 0.85 μm, but a micro-bending loss was generated in the wavelength of 1.3 μm. However, if the diameter D of the buffer layer 20 was set to 920 μm or above, a micro-bending loss was not generated in the entire wavelength range of both of the single-mode optical fiber and the multi-mode optical fiber. Meanwhile, the optical fiber unit having 4-core optical fibers according to the BT standards as mentioned above preferably has a maximum diameter of 1080 μm and the outer layer 30 preferably has a thickness of 40 μm or more in order to protect the optical fiber 10, so the buffer layer 20 has a maximum diameter D of 1000 μm. Therefore, the buffer layer 20 of the optical fiber unit having the 4-core optical fibers 10 preferably has a diameter D of 900 to 1000 μm, more preferably 920 to 1000 μm.

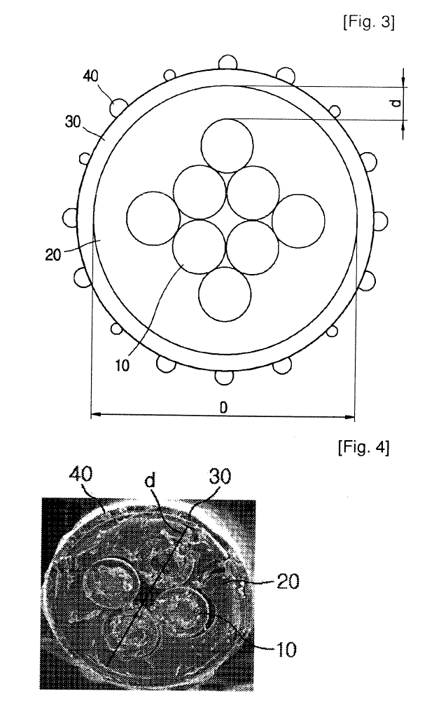

In addition, in case of an optical fiber unit having 8-core optical fibers as shown in FIG. 3, optical fiber units were prepared using a single-mode optical fiber usable in a wavelength range of 1.3 to 1.55 μm and a multi-mode optical fiber usable in a wavelength range of 0.85 to 1.3 μm with changing a diameter D of the buffer layer 20, and then their optical losses were measured. At this time, the buffer layer 20 is set to have a Young's modulus in the range of 0.05 to 2 kgf/mm².

As a result of the measurement, in case the diameter D of the buffer layer 20 was less than 1280 μm, a micro-bending loss was generated in the entire wavelength range of both of the single-mode optical fiber and the multi-mode optical fiber. In addition, in case the diameter D of the buffer layer 20 was in the range of 1280 to 1300 μm, a micro-bending loss was not generated in the wavelength of 1.3 μm in case of the single-mode optical fiber, while a micro-bending loss was generated in the wavelength of 1.55 μm. In case of the multi-mode optical fiber, a micro-bending loss was not generated in the wavelength of 0.85 μm, but a micro-bending loss was generated in the wavelength of 1.3 μm. However, if the diameter D of the buffer layer 20 was set to 1300 μm or above, a micro-bending loss was not generated in the entire wavelength range of both of the single-mode optical fiber and the multi-mode optical fiber. Meanwhile, the optical fiber unit having 8-core optical fibers according to the BT standards as mentioned above preferably has a maximum diameter of 1450 μm, and the outer layer 30 preferably has a thickness of 40 μm or more in order to protect the optical fiber 10 as mentioned above, so the buffer layer 20 has a maximum diameter D of 1370 μm. Therefore, the buffer layer 20 of the optical fiber unit having the 8-core optical fibers 10 preferably has a diameter D of 1280 to 1370 μm, more preferably 1300 to 1370 μm.

### Mode for the Invention

Hereinafter, an optical loss of an optical fiber unit whose thickness and diameter of the buffer layer, and Young's modulus are controlled according to the prefested embodiment of the present invention will be compared with an optical loss of a conventional optical fiber unit.

### Embodiment

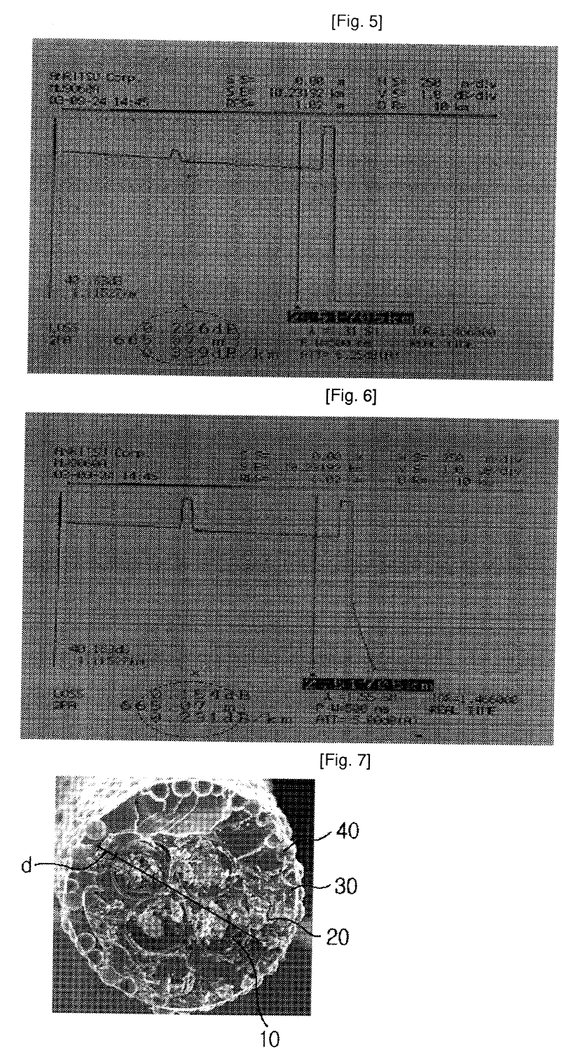

A buffer layer 20 was prepared on an outer circumference of 4-core single-mode optical fibers by using acrylate having Young's modulus of 1.5 kgf/mm² so that its thickness and diameter were respectively 70 μm and 940 μm. In addition, an outer layer 30 was formed on the buffer layer using aciylate having Young's modulus of 70 kgf/mm² to have a thickness of 45 μm so that the optical fiber unit has a total diameter of 1030 μm. After that, glass beads were attached to the surface of the outer layer by means of particle scattering before the outer layer was cured. FIG. 4 is a photograph showing a section of the optical fiber unit manufactured as mentioned above according to the present invention. Referring to FIG. 4, it would be found that optical fibers are arranged at the center of the optical fiber unit and the thickness d of the buffer layer is kept constantly. FIGS. 5 and 6 show measurement results where optical losses at wavelengths of 1.31 μm and 1.55 μm of the optical fiber unit are measured using OTDR (Optical Time Domain Refractometer). Referring to FIGS. 5 and 6, an optical loss was 0.339 dB/km at the wavelength of 1.31 μm, and an optical loss was measured to be 0.231 dB/km at the wavelength of 1.55 μm, which satisfy the optical loss standards.

### Comparative Example

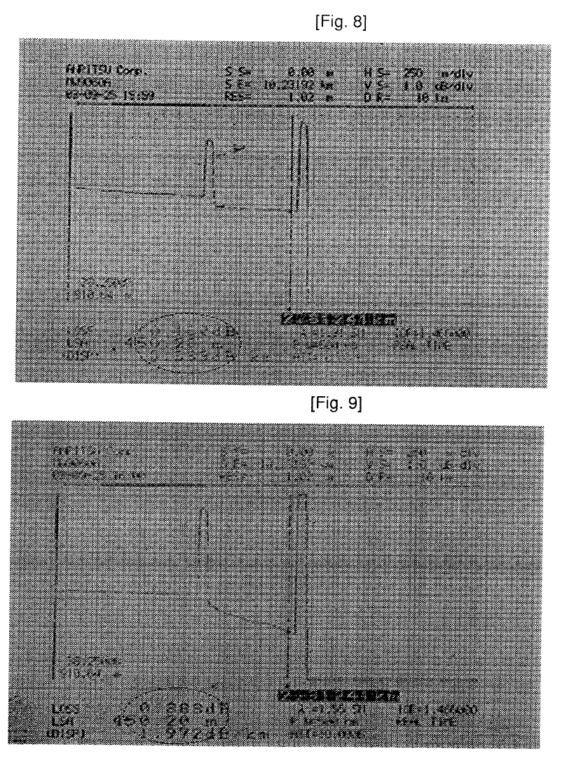

A buffer layer was prepared on an outer circumference of 4-core single-mode optical fibers by using acrylate having Young's modulus of 1.5 kgf/mm² so that its thickness and diameter were respectively 40 μm and 830 μm. In addition, an outer layer 30 was formed on the buffer layer using acrylate having Young's modulus of 70 kgf/mm² to have a thickness of 200 μm so that the optical fiber unit has a total diameter of 1030 μm. After that, glass beads were attached to the surface of the outer layer by means of particle scattering before the outer layer was cured. FIG. 7 is an enlarged photograph showing the optical fiber unit manufactured as mentioned above according to the prior art. Referring to FIG. 7, it would be found that optical fibers are deviated from the center of the optical fiber unit and the thickness d of the buffer layer is not uniform. FIGS. 8 and 9 show measurement results where optical losses at wavelengths of 1.31 μm and 1.55 μm of the optical fiber unit are measured using OTDR (Optical Time Domain Refractometer). Referring to FIGS. 7 and 8, an optical loss was measured to be 0.333 dB/km at the wavelength of 1.31 μm, which is satisfactory, but an optical loss was measured to be 1.9 dB/km at the wavelength ol 1.55 μm, which is quite different from the optical fiber unit shown in FIG. 4.

The present invention has been described in detail. However, it should be understood that the detailed description and specific examples, while indicating preferred embodiments of the invention, are given by way of illustration only, since various changes and modifications within the spirit and scope of the invention will become apparent to those skilled in the art from this detailed description.

### Industrial Applicability

The optical fiber unit according to the present invention may transmit optical signals reliably by buffering an external force applied to the optical fiber due to beads attached to its surface and thus reducing a micro-bending loss.

1. An optical fiber unit, comprising:
at least one optical fiber;
a buffer layer surrounding the optical fiber and made of polymer resin having a Young's modulus of 0.05 to 2 kgf/mm²; and
an outer layer surrounding the buffer layer and having beads attached to a surface thereof, the outer layer being made of polymer resin,
wherein the buffer layer has a thickness of 70 to 140 μm.

2. The optical fiber unit according to claim 1,
wherein 4-core optical fibers are used, and
wherein the buffer layer has a thickness of 70 to 110 μm.

3. The optical fiber unit according to claim 1,
wherein 8-core optical fibers are used, and
wherein the buffer layer has a thickness of 70 to 140 μm.

4. The optical fiber unit according to claim 1,
wherein the outer layer has a Young's modulus of 30 to 100 kgf/mm².

5. The optical fiber unit according to claim 1,
wherein 4-core optical fibers are used, and
wherein the buffer layer has a diameter of 920 to 1000 μm.

6. The optical fiber unit according to claim 1,
wherein 8-core optical fibers are used, and
wherein the buffer layer has a diameter of 1300 to 1370 μm.
